(19) United States
(12) Patent Application Publication
(10) Pub. No.: US 2024/0396489 A1
(43) Pub. Date: Nov. 28, 2024

(54) CARRYING AND FASTENING ARRANGEMENT FOR SOLAR MODULES

(71) Applicant: ClickCon GmbH & Co. KG, Freiburg (DE)

(72) Inventors: Max Dreger, Freiburg (DE); Alexander Koller, Opfingen (DE)

(21) Appl. No.: 18/721,950

(22) PCT Filed: Dec. 21, 2022
(86) PCT No.: PCT/EP2022/087242

§ 371 Date: Jun. 20, 2024

(30) Foreign Application Priority Data
Dec. 21, 2021 (EP) 21216315.8

(51) Int. Cl. H02S 20/23

(52) U.S. Cl. CPC H02S 20/23

(57) ABSTRACT

A carrying arrangement is provided to support solar modules spaced apart from a surface covered with said solar modules. At least two carrier channel profiles extend parallel and have a carrier bar and with first and second longitudinal faces, a plurality of solar modules provided between the carrier bars, with a plurality of rung parts, which extend between the channel profiles and at least indirectly support adjacent solar modules, with holding elements, which are detachably connectable to a first longitudinal face of the carrier bar of a first carrier channel profile. Locking elements are movable along a longitudinal extension in a guide of a rung part and connected to the second longitudinal face by displacement along the guide, such that ends of the solar modules are held and locked together and are locked by the locking element and by the change in cross section of the carrier bar.

### CROSS REFERENCE TO RELATED APPLICATION(S)

This application is a Section 371 National Stage Application of International Application No. PCT/EP2022/087242, filed on Dec. 21, 2022, which published as WIPO Publication No. WO 2023/118299 A1, on Jun. 29, 2023, not in English, which claims priority to European Patent Application No. 21216315.8, filed on Dec. 21, 2021, the contents of which are incorporated herein by reference in their entireties.

### TECHNICAL FIELD

The invention relates to a carrying arrangement provided and set up to support solar modules spaced apart from a surface covered with said solar modules.

### BACKGROUND

Solar modules are arranged in various configurations on surfaces accessible to solar radiation. Carrying arrangements are used to support a number of solar modules and hold them stationary, for example with respect to a roof surface. In the meantime, carrying arrangements have also become known which in principle support solar modules at any desired height and inclination with respect to a base surface and thus form a roof installation.

Once the carrying and fastening arrangement (for simplicity, also referred to as a carrying arrangement for short hereinafter) is located together with the solar modules-outside, naturally—it is of course exposed to all occurring weather phenomena, which may involve significant temperature fluctuations as well as impingement of a wide range of particles plus water in various physical states (water, snow, ice). This results in parts of the carrying arrangement and of the solar modules which are otherwise generally framed expanding and contracting, and moreover, for example, water in the form of rain should be and has to be discharged from the surfaces of the solar modules. At elevated temperatures, for example in summer, it is also advantageous for the carrying arrangement to be appropriately rear-ventilated to dissipate heat.

### SUMMARY

The object of the present invention is therefore to provide a carrying arrangement for solar modules which holds the solar modules of various manufacturers, having different geometric dimensions, securely on the carrying arrangement in such a way that there is no displacement of the solar modules relative to one another and/or to the carrying arrangement, the carrying arrangement and the solar modules being permitted to expand or contract mutually independently, and also provides an option to discharge moisture from the outer face of the carrying arrangement, substantially in such a way that it does not impinge on the covered surface and a tight roof covering is formed by the construction without the use of rubber seals.

This object is achieved by a carrying arrangement having the features of claim 1. The solution according to the invention thus in particular involves said arrangement having at least two carrier channel profiles, which extend mutually parallel, lie in a plane, and are each provided with a carrier bar and provided with a first and a second longitudinal face on said carrier bar, a plurality of solar modules being provided between the carrier bars of the at least two carrier channel profiles and lying side by side along their longitudinal faces in the use position. Further, a plurality of rung parts are provided, which each extend between the at least two parallel carrier channel profiles and at least indirectly support frame pieces of two adjacent solar modules. Moreover, a plurality of holding elements is provided, which are held and supported detachably connectable to a first longitudinal face of the carrier bar of a first of the at least two carrier channel profiles, an associated rung part receiving at its first end, in an engagement portion, a free end of a holding element at the end face. Finally, the carrying arrangement has a plurality of locking elements, which are each arrangeable or arranged on a second end of one of the rung parts, said end facing the second longitudinal face of a carrier bar of a second of the at least two carrier channel profiles, each of the locking elements being set up to be movable along its longitudinal extension in a guide on the second end of the associated rung part and to be connected to the second longitudinal face of the carrier bar of the second carrier channel profile by displacement along the guide, in such a way that the ends of the solar modules facing the second carrier channel profile are held and locked together with the end of the rung parts on the carrier bar of the second carrier channel profile.

Advantageously, the system may be mounted and the locking element may be locked both from below and from above, greatly facilitating handling the carrier arrangement.

According to the invention, solar modules are thus arranged between carrier channel profiles of the carrying arrangement which extend parallel, two adjacent solar modules engaging, by way of their mutually opposite frame elements, in rung parts, which extend between the carrier channel profiles and are in turn fixed via holding and locking elements to the different faces of a carrier bar of the carrier channel profiles.

As a result of the feature combination disclosed above, the solar modules are held securely on the carrier channel profiles, and the solar modules grouped into a module field and the carrier channel profiles are also thermally decoupled, in such a way that independent expansion and shrinking of the components is made possible, and moisture can also be discharged from the modules in a simple manner. As a result of water flowing off into the lower of two carrier channel profiles in each case, a module field having solar modules arranged in rows on the carrying arrangement can be drained in rows.

This results in a static carrier channel structure, which can in principle be scaled as desired and which implements a self-supporting photovoltaic (PV) roof system, which is tight without rubber seals, by way of screw-free connection of this structure to PV modules (solar modules). It is also irrelevant whether the solar modules are arranged longitudinally or transversely in the arrangement, and there is no preferred direction for the orientation thereof.

Preferred developments of the carrying arrangement according to the invention can be found in the dependent claims.

An advantageous development of the carrying arrangement may involve the first longitudinal face and second longitudinal face of the carrier bars of the at least two carrier channel profiles differing and the at least two carrier channel profiles each being provided with a base from which the carrier bar in question projects. As a result of the formation with two differing longitudinal faces, it is possible to provide different devices and mechanisms for fixing the two ends of each of the plurality of rung parts on opposite carrier channel profiles. Each carrier bar is expediently stabilised by the associated base.

In the carrying arrangement according to the invention, a plurality of carrier channel profiles may be arranged in succession in the extension direction thereof in each case. For this purpose, in a further development of the carrying arrangement, longitudinal faces of the carrier channel profiles are formed mutually spaced apart in each case and connected at their upper and lower ends by the carrier channel profile base and a roof piece in each case, forming a cavity on the carrier channel profile in each case. A reinforcing or connecting element may be fully introduced into said cavity if a carrier channel profile itself already spans a wide space, and so the two ends of a reinforcing element can be introduced into cavities which are assigned to two adjacent carrier channel profiles in the longitudinal direction, in such a way that the carrier channel profiles can in principle be extended as desired in their longitudinal direction by means of the reinforcing elements in the cavities.

As mentioned previously, further devices for supporting further elements of the carrying arrangement may be provided on the bases of the at least two profiles. In a preferred development of the carrying arrangement the base of the at least two carrier channel profiles has, on each longitudinal face of the associated carrier bar a support element, which projects from the base and the end of which carries an end region of a rung part.

The relevant end region of the rung part need not necessarily be positioned directly on the free end of the support element. Moreover, further devices, which are beneficial for the stability and/or fixing of the carrying arrangement and which are preferably located in the end regions of the support elements, may be provided on the support elements. Thus, for example, engagements, which can be engaged for example with hook-like projections of an associated clamping element, may be provided on the end regions of the support elements in each case. Said clamping element may be provided to fix a carrier channel profile to a roof structure. By means of these devices, a rung part can also be fixed to a support element, and this is advantageous for example in the region of the verge.

The construction having the rung parts may be given additional stability by a development in which a cross beam is arrangeable or arranged between two rung parts, preferably between every two rung parts. As a result, the carrying capacity of the carrying arrangement according to the invention can be improved, for example for heavy snow loads and wind loads.

In a further advantageous development of the carrying arrangement, as regards the rung parts extending between the at least two parallel carrier channel profiles, these may have an upwardly open cross section of a predeterminable length, in particular a C- or U-shaped cross section, in which frame pieces of adjacent solar modules engage in each case and are received in the open cross section of the associated rung part in such a way that they extend mainly parallel opposite one another between the two carrier channel profiles. The rungs further provide drainage between the modules and pass the water into the water-carrying space within the carrier channel profiles.

Prefabricated solar modules from different manufacturers may each be provided with different frame pieces, which in particular have a different vertical extension. Particularly preferably, therefore, in a further development of the carrying arrangement, each rung part may be assigned at least one spacer, which is detachably received in the cross section of the rung part and forms a support for the frame pieces, received in the cross section, of the solar modules. The spacer is adaptable or adapted to the vertical extension of the frame piece of the solar module(s) in each case, in such a way that the solar modules can all project with from the base of the rung parts with the same vertical magnitude in each case and can form a uniform surface towards the outside. The spacers are held in the cross section of the rung parts by their material flexibility and shape, which permits a bias with respect to the side walls of the rung parts. A plurality of spacers may also be provided for each rung part, further improving the support of the frame pieces.

According to the invention, the carrying arrangement is provided with a plurality of holding elements, which are held and supported so as to be detachably connectable to a first longitudinal face of the carrier bar. So as to be able to hold the regions of solar modules substantially stationary suitably securely in connection with the rungs and locking element, each of the holding elements has a receptacle, approximately C-shaped in cross section and having a receiving base arranged parallel to the carrier bar. From the ends of the receiving base, which are vertically spaced apart, the limbs of the receptacle project substantially transversely, substantially in such a way that the aforementioned corner regions of two adjacent solar modules are enclosed by the receptacle from at least two sides.

For covering differently sized surfaces, solar modules of different planar extensions are available. So as to be able to adapt the carrying arrangement to these different extensions, for example in terms of a transverse extension of the solar modules which extends parallel to the carrier bars, each of the holding elements may be provided displaceable along the first longitudinal face of the carrier bar, the holding element engaging, via a hook-like projection on the face of the receiving base facing the first longitudinal face, in a hinge opening on the longitudinal face, causing the holding element to be installed pivotably with respect to the carrier bar. Because of this pivotability, the receiving base of the C-shaped receptacle of the holding element can be pivoted with respect to the first longitudinal face of the carrier bar, causing the end of the hook-like projection sticking into the hinge opening to be released from a sort of clamping and then in particular to become displaceable along the longitudinal face of the carrier bar in a simple manner. Even in a locked state, the holding element can be displaced slightly. This ensures that no thermally induced stresses occur in the system. The holding elements further ensure a distance between the solar module and the carrier bar, and thus enable rear ventilation and drainage of the modules.

In a further development of the carrier arrangement, the holding element is supported, via a support bar, on the first longitudinal face of the carrier bar, in such a way that a solar module received in the receptacle of the holding element can be supported on the carrier bar via the receiving base of the receptacle.

So as to be able to fix each of the holding elements to the carrier bar in the desired position after determining the associated location, in an advantageous development of the carrying arrangement according to the invention, the holding element may be fixed to the carrier bar. For this purpose, the free end, received in the engagement portion of the rung part, of the holding element and a latch arm, the free end of which is set up to latch to a latch projection on the carrier bar (on the longitudinal face of the carrier bar) and thus to fix the holding element, may expediently be arranged on an end of the receptacle facing the base of the carrier channel profile. For example, the latch arm may form a curved portion of the holding element and, whilst being arranged on an end of the receptacle facing the base of the carrier profile, be arranged on the free end of the limb facing the rung part. The end of the curved portion may in turn be provided with a latch tab which, under corresponding pressure against the holding elements towards the carrier bar, is latched to the latch projection which projects obliquely from the carrier bar towards the base of the carrier channel profile. Preferably, the curved portion of the latch arm may describe an angle of approximately 90°, but for example other angular positions with respect to the latch projection are conceivable. Likewise, the entire latch arm may also be formed in a different construction.

So that the plurality of locking elements can each be kept flexible in their configuration according to shape, at least within limits, so as to be adaptable to particular structural changes in the carrier bar with: its second longitudinal face, in a further development of the carrying arrangement it may be provided to provide the locking elements with a holding member, a bolt member and a guide member as multiple members, the holding member and the bolt member extending substantially parallel to one another and to the second longitudinal face of the carrier bar, whilst the guide member projects transverse thereto towards the rung part. The members in a parallel arrangement, in other words the holding member and the bolt member, may be gradated parallel to one another, in other words with an oblique connecting piece between them in such a way that the two members attach to one another. However, the two members may also be formed collinear. In this case, in the region of the connecting pieces, in other words the gradation between the members, the holding member pointing away from them may be placed. A type of three-winged but single-piece structure is thus conceivable for the locking element.

According to the invention, while the locking element is locked by moving along the rung part with its free end, the bolt member of the locking element is set up to overcome a change in cross section of the second longitudinal face of the carrier bar, which blocks the reverse movement of the locking element in such a way that the relevant locking can only be undone again with some exertion of force, which pushes the bolt member back behind the change in cross section. The change in cross section may for example be formed in such a way that, towards the carrier channel profile base, the relevant longitudinal face of the carrier bar itself forms a recess, which the bolt member, and with it the locking element, overcomes during locking, and against which the bolt member impacts during the reverse movement so as to be restrained. During the locking process, aside from a displacement of the two solar modules which engage in the rung part towards the first longitudinal face of an opposite carrier channel profile, no further force is exerted on the solar module, and so the solar modules are arranged on the carrying arrangement without mechanical stress in their use position. Moreover, they are thermally decoupled from the carrier channel profiles, by way of the fixing via the holding elements and locking elements, in such a way that they can expand and contract mutually independently.

Both for the holding element and for the locking element, whilst each component is stable, some flexibility is beneficial for its functionality, for example in such a way that the blot member of the locking element can overcome the change in cross section. For appropriate structures having suitable material flexibility, components may for example be formed at least in part of aluminium. However, other materials are also conceivable.

So that the carrying arrangement according to the invention can itself form a tight roof covering, which suitably roofs over a region located below it, an advantageous development provides that the carrier channel profiles are each connectable or connected to a structural element of a roof structure. In this context, the carrier channel profiles may for example be fixed to the rafters as structural elements of a roof structure, for which purpose they can be fixed by means of clamping elements, which can be engaged for example with a corresponding receptacle on the support elements of the carrier channel profiles. However, other fixings are possible. Moreover, the carrier channel profiles are connected to purlins as structural elements so as to achieve greater spans. They may for example be connected thereto by screwing or welding.

In the context of discussing the cavity on the carrier bar, it has already been addressed that the carrier channel profiles of the carrying arrangement can be continued, in other words extended, along their longitudinal direction by identical, in particular identically constructed, carrier channel profiles, making in principle unlimited extension possible in a first laying direction (and thus also spatial direction). Moreover, in a further development of the carrying arrangement, a number n of mutually parallel carrier channel profiles may be provided, n being a natural number greater than or equal to two, the spatial direction perpendicular to the previous one likewise being unlimited.

So as to be able to adapt to particular geometric requirements, such as changes in the base profile, but also so as to be able to do some justice with regard to aesthetic factors, in a further development of the carrying arrangement the carrier channel profiles may be provided to arrange the solar modules of the carrying arrangement relative to one another in such a way that the solar modules all form surface pieces of the same plane or curved surface. This means that, in the case of purely horizontal extension in the two mutually perpendicular spatial directions, not only do the solar modules form a tight roof covering, but the module field is also substantially planar. Moreover, however, for example for correspondingly curved rung parts, the carrying arrangement may also have a curved cross section, in such a way that for example a curved surface can be implemented in the region of a roof ridge by means of the carrying arrangement. Various constructions are conceivable in this context, irrespective of the curvature of the solar modules, and can together, arranged side by side or even in succession, form for example a type of curved row.

The above configurations and developments can, where expedient, be combined with one another as desired. Further possible configurations, developments and implementations of the invention also include combinations not explicitly mentioned of features of the invention which are described above or in the following in relation to the embodiments.

### BRIEF DESCRIPTION OF THE DRAWINGS

In the following, the invention is described in greater detail by way of embodiments in the drawings, in which, in a partially schematic representation:

FIG. 1 shows the mounting situation of a carrying arrangement in a planar side view of a first embodiment, having two mutually opposite carrier channel profiles, rung parts which extend between the carrier channel profiles, and solar modules arranged on the carrying arrangement, on an oblique roof surface in such a way that the carrying arrangement has a ridge side on the right and an eaves side on the left;

FIGS. 2a, 2b are a planar side view of a second embodiment of a carrying arrangement having two mutually opposite carrier channel profiles and having non-integrated rung parts which extend between the carrier channel profiles, in which the carrier channel profiles are of the same height (FIG. 2a), and an enlargement of an end region of a rung part on which a locking element is arranged (FIG. 2b);

FIGS. 3a, 3b are a planar side view of the carrying arrangement of FIGS. 2a, 2b having a locking element arranged on one rung end, the rung part being moved towards the first carrier channel profile, on the first longitudinal face of which the holding element is arranged;

FIGS. 4a, 4b are a planar side view of the carrying arrangement of FIGS. 3a, 3b, in which the end region of the rung part facing the first carrier channel profile receives the bolt member of the locking element, and the other end of the rung part is pivoted towards the second carrier channel profile and inserted into the holding element;

FIGS. 5a, 5b are a planar side view of the carrying arrangement of FIGS. 4a, 4b, in which the end region of the rung part facing the second carrier channel profile is pivoted against the rung part and the locking element is pulled out;

FIGS. 6a, 6b are a planar side view of the carrying arrangement of FIGS. 5a, 5b, in which a solar module is arranged on the carrying arrangement, an end region of the solar module initially being arranged in the vicinity of the second carrier channel profile;

FIGS. 7a, 7b are a planar side view of the carrying arrangement of FIGS. 6a, 6b, in which the other end of the solar module is pivoted into the vicinity of the first longitudinal face of the first carrier channel profile;

FIGS. 8a, 8b are a planar side view of the carrying arrangement of FIGS. 7a, 7b, in which the solar module is fixed to the carrying arrangement by locking the locking element on the second longitudinal face of the second carrier channel profile and fixed by way of a change in position of the locking element towards the rung;

FIGS. 9a, 9b are a perspective top view of a detail of a carrying arrangement without solar modules (FIG. 9a) and an enlargement of the end-face region of a carrier channel profile along with the two longitudinal faces;

FIG. 10 is a perspective top view of the detail of a carrying arrangement of FIG. 9 with solar modules arranged thereon; and

FIG. 11 is a planar side view of an embodiment of the carrying arrangement, in which a carrier channel profile is connected to a purlin of a roof structure.

The accompanying drawings are intended to convey a deeper understanding of the embodiments of the invention. They illustrate embodiments and, together with the description, serve to explain principles and concepts of the invention. Other embodiments and many of the stated advantages will be apparent in view of the drawings. The elements of the drawings are not necessarily shown to scale with one another.

Unless stated otherwise, like or functionally equivalent elements and devices are provided with like reference numbers throughout the drawings.

### DETAILED DESCRIPTION OF EMBODIMENTS

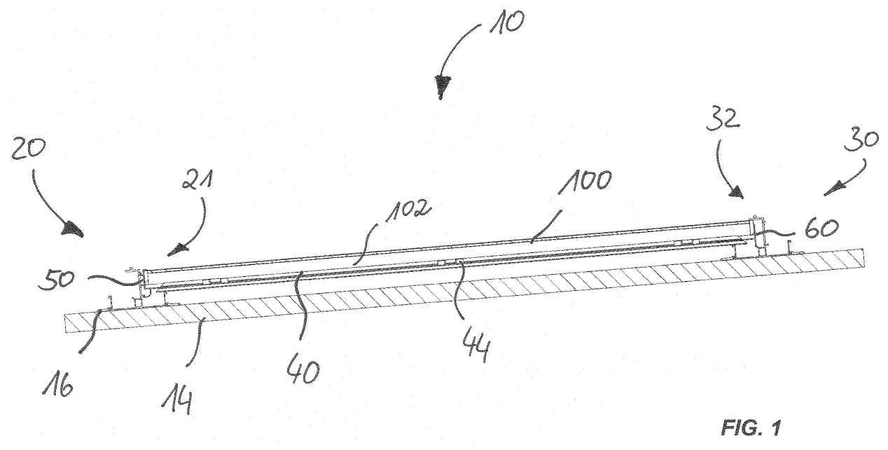

FIG. 1 is a planar side view of a first embodiment of a carrying arrangement, denoted as a whole as 10, having two mutually opposite carrier channel profiles 20, 30, rung parts 40 which extend between the carrier channel profiles 20, 30, and solar modules 100 arranged on the carrying arrangement 10, the carrying arrangement being fixed to a roof rafter 14 by means of clamping elements 16 and having a ridge side and an eaves side. FIG. 1 shows the mounting situation of the carrying arrangement 10, in which solar modules are arranged, by means thereof, on a roof structure, here in the form of a rafter 14. The upper ridge side is located in the second carrier channel profile 30, shown on the right in the drawing, whilst the lower, eaves side is located in the first carrier channel profile 20, shown on the left in the drawing. A rung part 40 extends between the mutually parallel carrier channel profiles 20, 30, and receives a frame piece 102, extending parallel to the rung part 40, of a solar module 100. The solar module 100 is held on the carrying arrangement 10 between the two carrier channel profiles 20, 30. More precisely, it extends between the first longitudinal face 21 of the first carrier channel profile 20 and the second longitudinal face 32 of the second carrier channel profile 30. The solar module is fixed on the carrying arrangement 10 by the holding element 50, located on the first longitudinal face 21 of the first carrier channel profile 20, and the locking element 60, located on the second longitudinal face 32 of the second carrier channel profile 30. It can further be seen in FIG. 1 that the solar module 100 is supported, by its frame piece 102, on spacers 44, which are assigned to the rung part 40 and support the frame pieces 102 with respect to the base of the rung part 40. Further reference numerals are omitted in FIG. 1 for clarity.

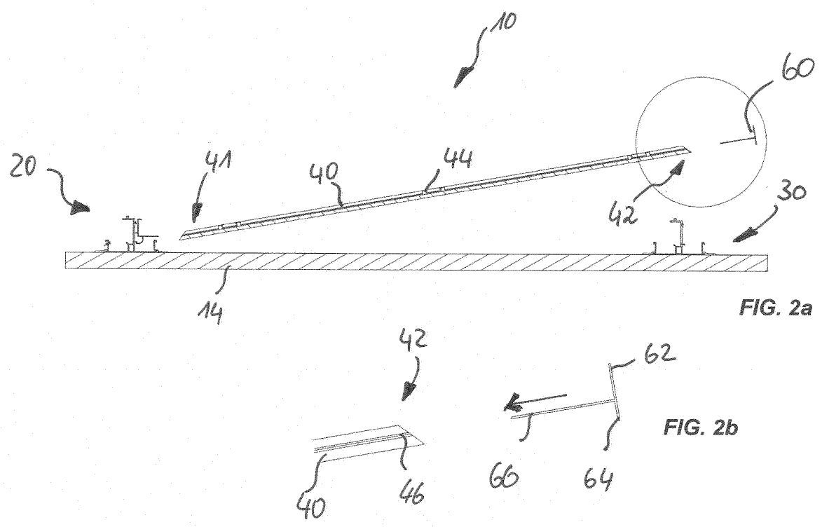

The following FIGS. 2 to 8 show a temporal sequence of mounting a carrying arrangement 10 having first and second carrier channel profiles 20, 30, rung parts 40 which extend between these, holding elements 50 and connecting elements 60.

FIGS. 2a, 2b are a planar side view of a second embodiment of a carrying arrangement 10 having two mutually opposite carrier channel profiles 20, 30 and having rung parts 40 which extend between the carrier channel profiles 20, 30, in which the carrier channel profiles 20, 30 are of the same height (FIG. 2a), and an enlargement of an end region of a rung part on which a locking element 60 is arranged (FIG. 2b). Here, a guide member 66 of the locking element 60 is introduced in the arrow direction into a guide 46 on the second end 42 of the rung part 40. The first end 41 of the rung part 40 is brought into the vicinity of the first carrier channel profile 20 of the carrying arrangement so as to be arranged there.

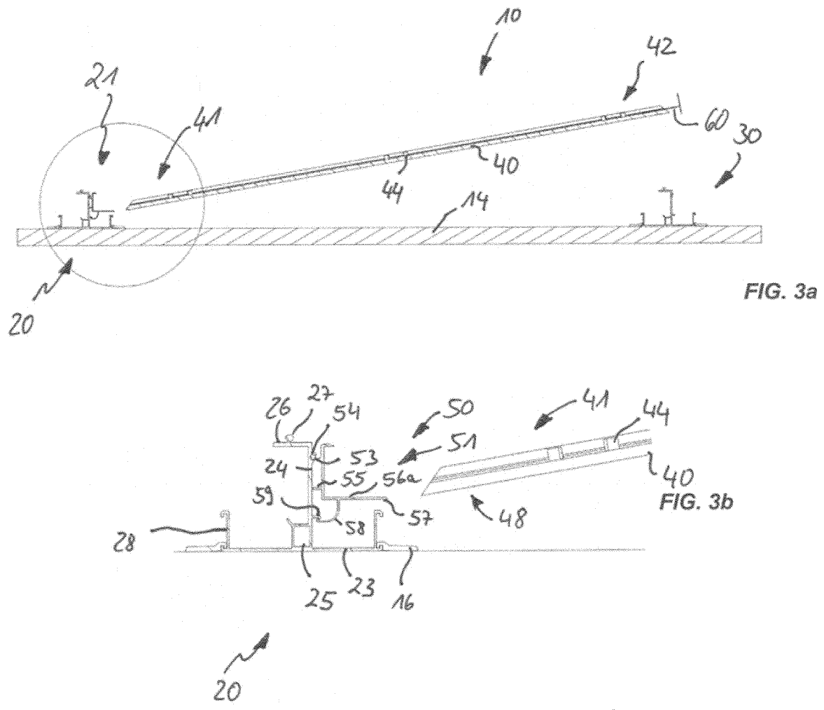

FIGS. 3a, 3b are a planar side view of the carrying arrangement of FIGS. 2a, 2b having a locking element 60 arranged on one rung part end 42, the rung part 40 being moved towards the first carrier channel profile 20, on the first longitudinal face 21 of which the holding element 50 is arranged. On the first carrier channel profile 20, its structure, also valid for the second (identical) carrier channel profile, can be seen, with a carrier channel profile base 23 and a carrier bar 24, arranged on the carrier channel profile base 23 and projecting therefrom and having a cross bar 26. Moreover, a support element 28, 29 for supporting rung parts 40 projects from the carrier channel profile base at each longitudinal face 21, 22, the support elements 28, 29 being orientated substantially parallel to the carrier bar 24.

The holding element 50 arranged on the carrier channel profile 20 in FIG. 3b forms a receptacle 51, which is formed approximately C-shaped in cross section and is parallel to the carrier bar 24. The holding element 50 is provided displaceable along the first longitudinal face 21 of the carrier channel profile 20 or of the carrier bar 24, and engages, with a hook-like projection 53 on the face of the receptacle base 52 facing the longitudinal face, in a hinge opening 54, causing the holding element 50 to be set up pivotably with respect to the carrier bar 24. Moreover, the holding element 50 is supported by a support bar 55 on the first longitudinal face 21 of the first carrier groove profile 20 or of the carrier bar 24. The free end 57, received in the engagement portion 48 of the rung part 40, of the holding element 50 and a latch arm 58, the free end of which is set up to latch to a latch projection 59 on the carrier bar 24 and thus to fix the holding element 50 and thus subsequently the solar module 100, are arranged on a receiving limb 56a, facing the carrier channel profile base 23 of the carrier channel profile 20, of the receptacle 51.

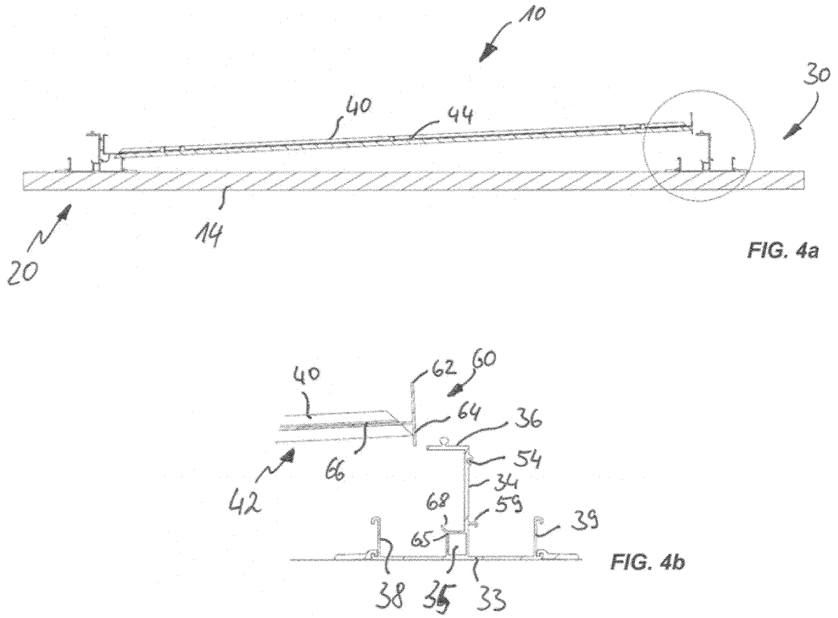

FIGS. 4a, 4b are a planar side view of the carrying arrangement 10 of FIGS. 3a, 3b, in which the end region 41 of the rung part 40 facing the first carrier channel profile 20 receives the free end 57 of the holding element 50, and the other, second end 42 of the rung part 40 is pivoted towards the second carrier channel profile 30. The features of the second carrier channel profile are provided with the reference numerals assigned thereto, but the second carrier channel profile 30 may, if the carrying arrangement is continued to the right in the view of FIG. 4, in turn form a first carrier channel profile 20, and a second carrier channel profile 30 may be arranged further to the right. The same applies if the carrying arrangement is continued to the side on the viewer's left.

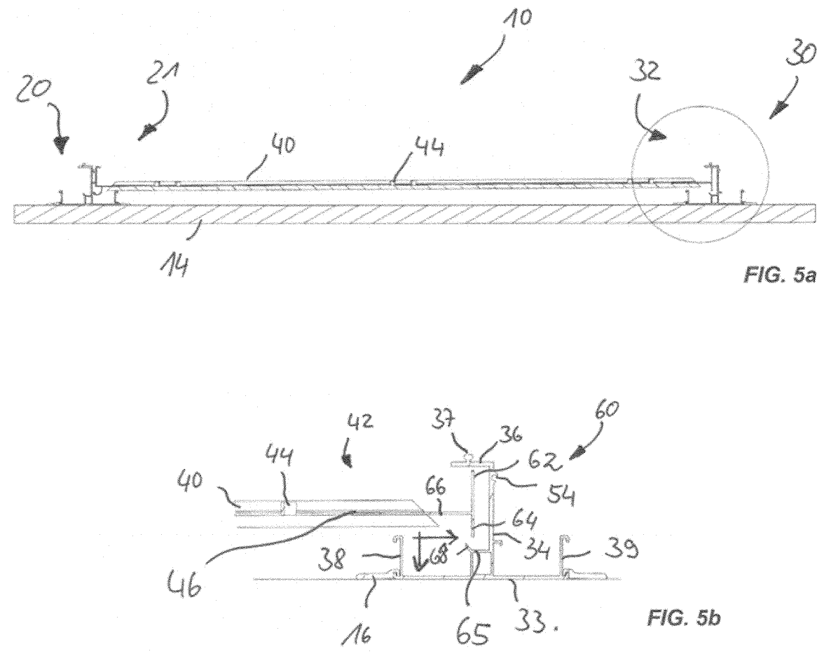

FIGS. 5a, 5b are a planar side view of the carrying arrangement 10 of FIGS. 4a, 4b, in which the second end region 42 of the rung part 40 facing the second carrier channel profile 30 is pivoted against the relevant carrier channel profile 30 shortly before the end region 42 of the rung part 40 comes to lie on the support element 38 of the second carrier channel profile 30. In FIG. 5b, it can be seen that in this position of the rung part 40 the locking element 60, arranged thereon and having its guide member 66 inserted into the guide 46, has its holding member 62 and bolt member 64 brought into the vicinity of the second longitudinal face 32 of the second carrier channel profile 30 in such a way that the end of the bolt member 64 engages a change in cross section 65 of the carrier bolt 34 from behind. The direction arrows here indicated that the end region 42 of the rung part 40 is moved down towards the support element 38 and the locking element 60 is moved to the viewer's right towards the carrier bar 34. From the locking member 60, it can be seen that the holding member 62 and the bolt member 64 are formed mutually collinear and the guide member 66 points towards the rung part 40.

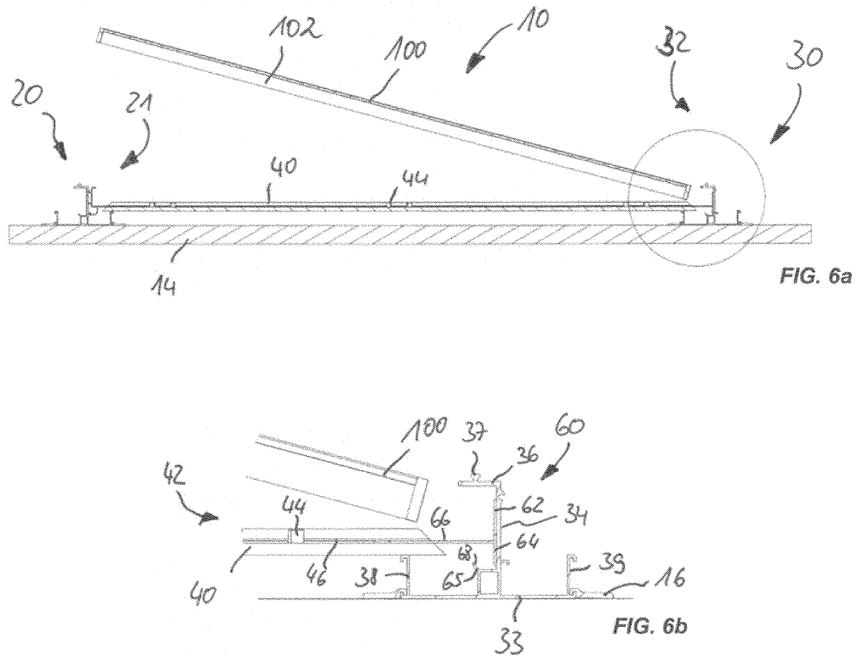

FIGS. 6a, 6b are a planar side view of the carrying arrangement 10 of FIGS. 5a, 5b, in which the rung part 40 extends between the carrier channel profiles 20, 30 and in which a solar module 100 is arranged on the carrying arrangement 10, an end region of the solar module 100 initially being arranged in the vicinity of the second longitudinal face 32 of the second carrier channel profile 30 and the second end region 42 of the rung part 40. The second end region of the rung part 40 is positioned on the support element 38 on the second longitudinal face 32 of the second carrier channel profile 30, whilst the holding member 62 of the locking element 60 is positioned against the second longitudinal face 32 of the second carrier channel profile and the free end of the bolt member 64 is supported on the change in cross section 65 of the carrier bar 34.

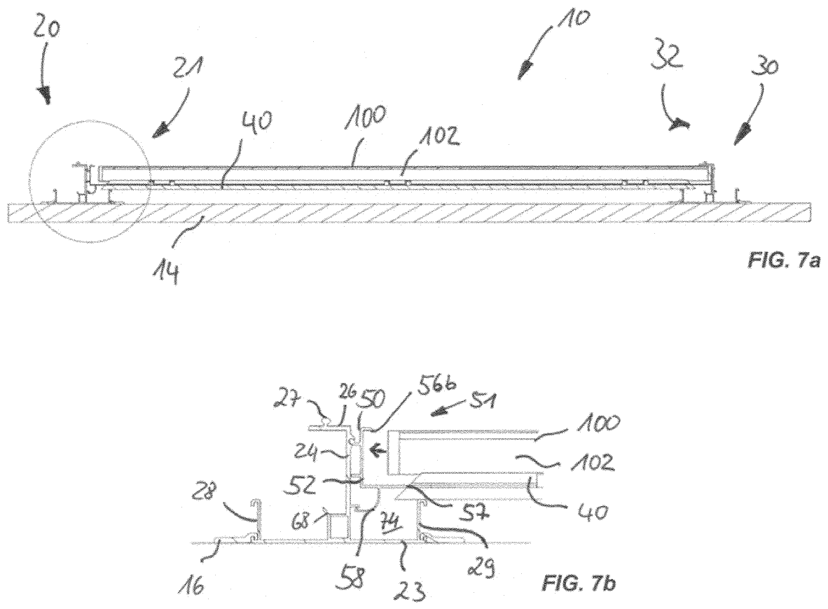

FIGS. 7a, 7b are a planar side view of the carrying arrangement 10 of FIGS. 6a, 6b, in which the frame piece 102 of the solar module 100 is received in the rung part 40 and the end-face end of the solar module 100, facing the first carrier channel profile 20, is moved towards the first longitudinal face 21 of the first carrier channel profile 20 by displacement, as indicated by the direction arrow in FIG. 7b. This end of the solar module engages below the receptacle limb 56b arranged at the upper end, remote from the carrier channel profile base 23, of the receptacle 51, and can now no longer deviate away from the carrier channel profile base 23. It can further be seen in the cross section of FIG. 7a that the carrier channel profile base 23, the support element 29 and the first end region 41 of the rung part 40, together with the free end 57 of the holding element 50 and the latch arm 58, the latch projection 59 and a lower portion of the carrier bar 24, encompass an structural space 74, which is continued in the viewing direction and is then not always fully enclosed and which is used for draining the carrier arrangement 10.

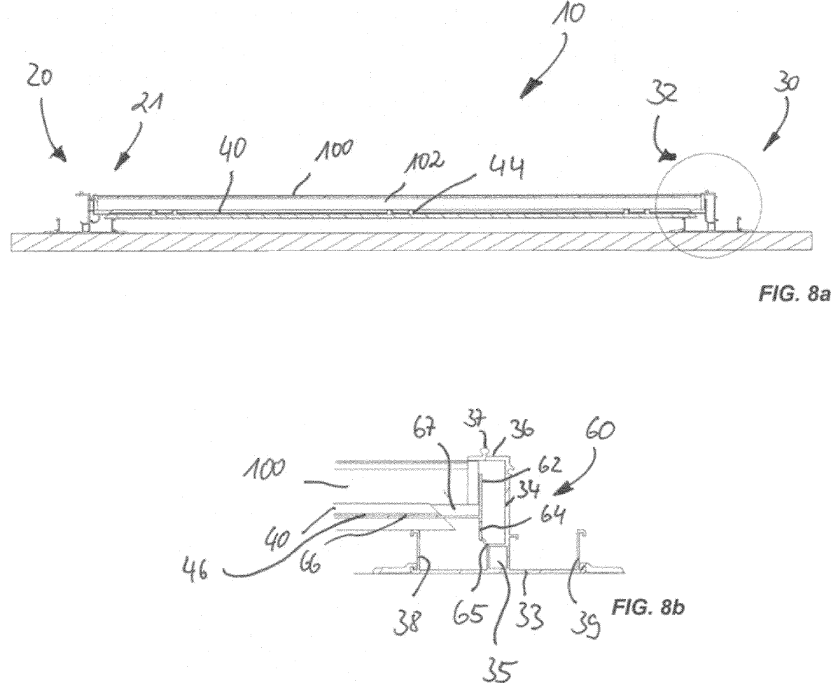

FIGS. 8a, 8b are a planar side view of the carrying arrangement 10 of FIGS. 7a, 7b, in which the solar module 100 is fixed to the carrying arrangement 10 by locking the locking element 60 on the second longitudinal face 32 of the second carrier channel profile 30. For this purpose, the locking element, guided on its guide member 66 in the guide 46 of the rung part 40, is moved towards the rung part 40, its bolt member 64 both being pressed in front of the change in cross section 65 because of its sufficient flexibility and, because of its sufficient rigidity and the shape of the change in cross section 65 of the carrier bar 34 as a recess 68 on the second longitudinal face 32 of the carrier channel profile 30, having no opportunity to engage with it again. Here, the change in cross section 65 of the carrier bar 34 consists in the cavity 35, which in cross section has a rectangular edge in one end region of which said recess 68 is built, being formed in the portion thereof facing the carrier channel profile base 33. Upwardly, the solar module 100 is secured here by a cross bar 36, which points transversely away from the carrier bar 34 and is arranged at the free end of the carrier bar 34 and projects therefrom and engages over end regions, facing this longitudinal face 32, of solar modules 100 arranged side by side, on the surface thereof. On the guide member 66 of the locking element, starting at the end facing the other members 62, 64, a diversion piece 67 is integrally formed on each of the two faces, and reaches far enough towards the free end of the locking piece that, regardless of the movement path of the locking member 66, a side region of the guide member 66 is never exposed without a diversion piece 67. In this way, moisture to be discharged from the solar modules 100 can be prevented from exiting from the cross section of the rung parts 40.

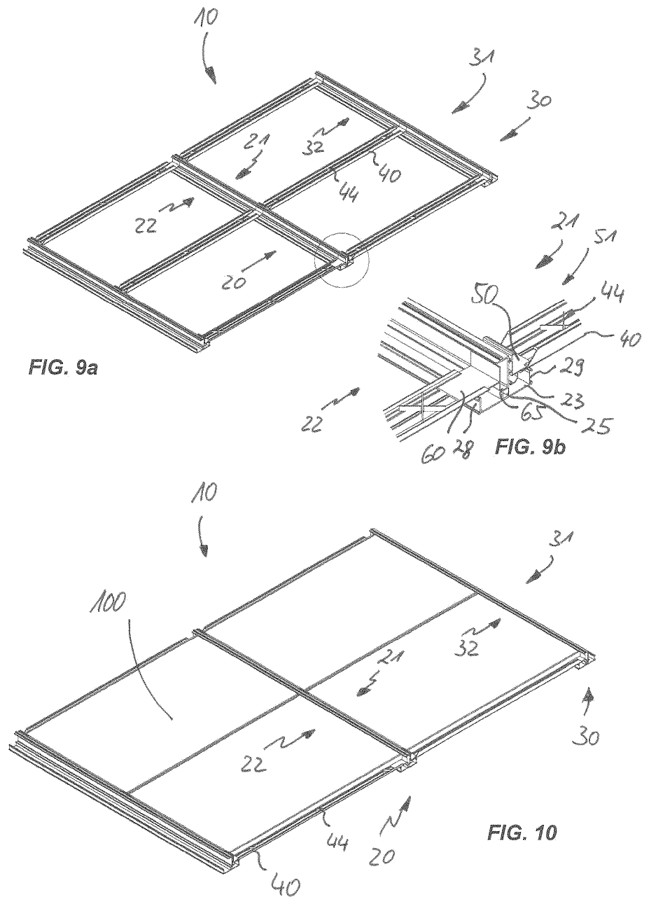

FIGS. 9a, 9b are a perspective top view of a detail of a carrying arrangement 10 without solar modules 100 and an enlargement of the end-face region of in principle any desired first or second carrier channel profile 20, 30 along with its two longitudinal faces 21, 22, 31, 32. It can be seen from FIG. 9a that the carrying arrangement 10 can be continued in both the longitudinal and the transverse direction. On a lateral end of the carrying arrangement, at a verge, because only one frame piece of a solar module 100 is to be held here a narrower rung part may be provided, in which only the one frame piece engages.

FIG. 10 is a perspective top view of the detail of a carrying arrangement 10 of FIG. 9, with here four shown solar modules 100, forming a detail of two parallel solar modules 100 in each case in two rows on the carrying arrangement, held by n=3 mutually parallel carrier channel profiles. It can clearly be seen in FIG. 10 that the rung parts 40 of the carrying arrangement 10 are arranged wherever the longitudinal faces of two solar modules 100 oppose one another adjacently, in such a way that the frame pieces of the two solar modules can jointly engage in the cross section of the assigned rung part. In FIG. 10, the solar modules 100 form surface pieces of the same plane. In the terminology of the present description, the first carrier channel profile 20 shown in FIG. 10 may in turn form a second carrier channel profile 30 in relation to the unlabelled rear part of the drawing, and the rear carrier channel profile may form a carrier channel profile 20. In the view of FIG. 10, if the carrying arrangement 10 were applied to a saddle roof (not shown), the second carrier channel profile 30 would face the ridge and the first carrier channel profile 20 would face the eaves.

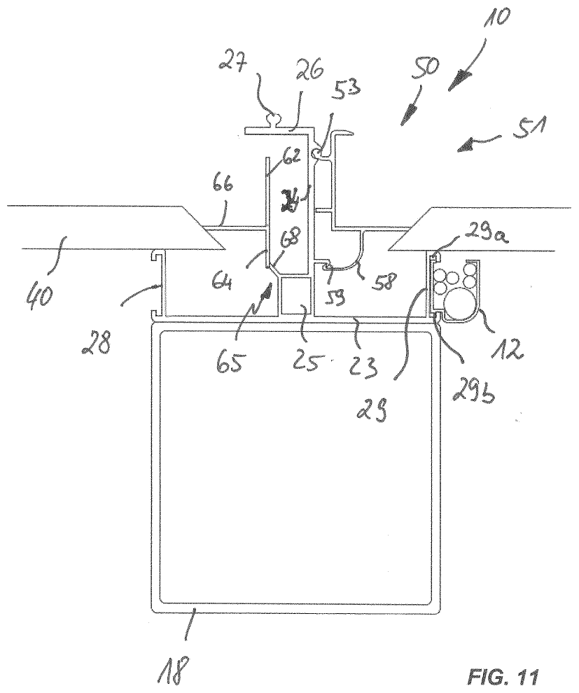

Finally, FIG. 11 is a planar side view of an embodiment of the carrying arrangement 10, in which a carrier channel profile 20 (without solar modules 100) is connected to a purlin 18 of a roof structure, for example by welding. The carrier channel profile base 23 spans the width of the purlin 18, which supports the carrier channel profile base 23 and thus the carrier channel profile 20 itself. Moreover, from the support element 29 of the carrier channel profile 20, it can be seen that on the engagements 29a, 29b thereof remote from the carrier bar 24 a cable duct 12 is suspended, which serves to electrify the module filed. This may also be suspended on the opposite face of the carrier bar. At the cross bar 26 located at the free end of the carrier bar 24, a guide projection 27 which faces the carrier channel profile base 23 can further be seen; for the carrier channel profile 30 of FIG. 8, said projection is denoted by reference numeral 37. By means of the guide projections, the carrying arrangement 10 can be travelled over using a travel system (not shown) guided on the guide projections 27, 37.

Thus, herein, according to the invention, a carrying arrangement 10 is created and made available, which is provided and set up to support solar modules 100 spaced apart from a surface covered with said solar modules 100, having at least two carrier channel profiles 20, 30, which extend mutually parallel and are each provided with a carrier bar 24, 34 and provided with a first longitudinal face 21, 31 and a second longitudinal face 22, 32 on said carrier bar, a plurality of solar modules 100 being provided between the carrier bars 24, 34 of the at least two carrier channel profiles 20, 30 and lying side by side along their longitudinal faces in the use position. The carrying arrangement 10 according to the invention has a plurality of rung parts 40, which each extend between the at least two parallel carrier channel profiles 20, 30 and at least indirectly support frame pieces 102 of two adjacent solar modules 100, and a plurality of holding elements 50, which are held and supported detachably connectable to a first longitudinal face 21 of the carrier bar 24 of a first of the at least two carrier channel profiles 20, an associated rung part 40 receiving at its first end 41, in an engagement portion, a free end 57 of a holding element 50 at the end face. Moreover, the carrying arrangement 10 according to the invention has a plurality of locking elements 60, which are each arrangeable or arranged on a second end 42 of one of the rung parts 40, said end facing the second longitudinal face 32 of a carrier bar 34 of a second of the at least two carrier channel profiles 20, 30, each of the locking elements 60 being set up to be movable along its longitudinal extension in a guide 46 on the second end 42 of the associated rung part 40 and to be connected to the second longitudinal face 32 of the carrier bar 34 of the second carrier channel profile 30 by displacement along the guide 46, in such a way that the ends of the solar modules 100 facing the second carrier channel profile 30 are held and locked together with the end 42 of the rung parts 40 on the carrier bar 34 of the second carrier channel profile 30.

Accordingly, it has been possible to show that the set object is achieved by the invention by way of a carrying arrangement 10 corresponding to the features of the main claim.

Although the present invention has been described herein by way of preferred embodiments, it is not limited thereto, but rather can be modified in various ways. In particular, the invention can be altered or modified in numerous ways without departing from the central idea of the invention.

### LIST OF REFERENCE NUMERALS

10 Carrying arrangement
12 Cable duct
14 Rafter
16 Clamping element
18 Purlin
20 First carrier channel profile
21 First longitudinal face of first carrier channel profile
22 Second longitudinal face of first carrier channel profile
23 Carrier channel profile base
24 Carrier bar
25 Cavity
26 Cross bar
27 Guide projection
28 Support element
29 Support element
29a, b Engagement on support element
30 Second carrier channel profile
31 First longitudinal face of second carrier channel profile
32 Second longitudinal face of second carrier channel profile
33 Carrier channel profile base
34 Carrier bar
35 Cavity
36 Cross bar
37 Guide projection
38 Support element
39 Support element
40 Rung part
41 First end/first end region of rung part
42 Second end/second end region of rung part
44 Spacer
46 Guide
48 Engagement portion
50 Holding element
51 Receptacle
52 Receptacle base
53 Hook-like projection
54 Hinge opening
55 Support bar
56a, b Receptacle limb
57 Free end of holding element
58 Latch arm
59 Latch projection
60 Locking element
62 Holding member
64 Bolt member
65 Change in cross section of carrier bar
66 Guide member
67 Diversion piece
68 Recess
74 Structural space for drainage
100 Solar module
102 Frame piece

1. Carrying arrangement provided and set up to support solar modules spaced apart from a surface covered with said solar modules, having at least two carrier channel profiles, which extend mutually parallel and are each provided with a carrier bar, which in turn has a first longitudinal face and a second longitudinal face in each case, a plurality of solar modules being provided between the carrier bars of the at least two carrier channel profiles and lying side by side along their longitudinal faces in the use position, having a plurality of rung parts, which each extend between the at least two parallel carrier channel profiles and at least indirectly support frame pieces of two adjacent solar modules,
having a plurality of holding elements, which are held and supported detachably connectable to a first longitudinal face of the carrier bar of a first of the at least two carrier channel profiles, an associated rung part receiving at its first end, in an engagement portion, a free end of a holding element at the end face, and
having a plurality of locking elements, which are each arrangeable or arranged on a second end of one of the rung parts, said end facing the second longitudinal face of a carrier bar of a second of the at least two carrier channel profiles, each of the locking elements-being set up to be movable along its longitudinal extension in a guide on the second end of the associated rung part and to be connected to the second longitudinal face of the carrier bar of the second carrier channel profile by displacement along the guide, in such a way that the ends of the solar modules-facing the second carrier channel profile are held and locked together with the end of the rung parts on the carrier bar of the second carrier channel profile.

2. Carrying arrangement according to claim 1, wherein the first longitudinal face and second longitudinal face of the carrier bars of the at least two carrier channel profiles differ and the at least two carrier channel profiles are each provided with a base from which the carrier bar in question projects.

3. Carrying arrangement according to claim 1, wherein longitudinal faces of the carrier channel profiles are formed mutually spaced apart in each case and connected at their upper and lower ends by the carrier channel profile base and a roof piece in each case, forming a cavity on the carrier channel profile in each case.

4. Carrying arrangement according to claim 2, wherein the base of the at least two carrier channel profiles has, on each longitudinal face of the associated carrier bar, a support element which projects from the base and the free end of which carries an end region of a rung part.

5. Carrying arrangement according to claim 1, wherein the rung parts have a predeterminable length and an upwardly open cross section, in particular a C- or U-shaped cross section, in which the frame pieces of the adjacent solar modules engage in each case.

6. Carrying arrangement according to claim 1, wherein each rung part is assigned at least one spacer, which is detachably received in the cross section of the rung part and forms a support for the frame pieces of the solar modules.

7. Carrying arrangement according to claim 1, wherein each holding element has a receptacle, approximately C-shaped in cross section and having a receiving base arranged parallel to the carrier bar, said receptacle engaging around the corner regions of two adjacent solar modules from at least two sides.

8. Carrying arrangement according to claim 1, wherein each of the holding elements is provided displaceable along the first longitudinal face of the carrier channel profile, said holding element engaging, via a hook-like projection on the face of the receiving base facing the first longitudinal face, in a hinge opening on the longitudinal face, causing the holding element to be installed pivotably with respect to the carrier bar.

9. Carrying arrangement according to claim 1, wherein the free end, received in the engagement portion of the rung part, of the holding element and a latch arm, the free end of which is set up to latch to a latch projection on the carrier bar and thus to fix the holding element, is arranged on a limb, facing the base of the carrier channel profile, of the receptacle.

10. Carrying arrangement according to claim 9, wherein a cross bar is arranged on the carrier channel profiles on the free end of the carrier bar, and projects from the second longitudinal face and engages around end regions, facing this longitudinal face, of solar modules-arranged side by side, on the surface thereof.

11. Carrying arrangement according to claim 1, wherein the locking elements are provided with a holding member, a bolt member and a guide member as multiple members, the holding member and the bolt member extending substantially parallel to one another and to the second longitudinal face of the carrier bar, whilst the guide member projects transverse thereto towards the rung part.

12. Carrying arrangement according to claim 11, wherein, while the locking element is locked by moving along the associated rung part with its free end, the bolt member of the locking element is set up to overcome a change in cross section of the second longitudinal face, which blocks a subsequent reverse movement of the locking element.

13. Carrying arrangement according to claim 1, wherein the carrier channel profiles are each connectable or connected to a structural element of a roof structure.

14. Carrying arrangement according to claim 1, wherein the carrying arrangement has a number n of mutually parallel carrier channel profiles, n being a natural number≥2, and/or the carrying arrangement is continuable or continued in the extension direction of the carrier channel profiles by arranging a plurality of carrier channel profiles in succession.

15. Carrying arrangement according to claim 1, wherein the carrier channel profiles are provided to arrange the solar modules of the carrying arrangement relative to one another in such a way that the solar modules all form surface pieces of the same plane or curved surface.
